(19) United States
(12) Patent Application Publication
(10) Pub. No.: US 2010/0293179 A1
(43) Pub. Date: Nov. 18, 2010

(54) IDENTIFYING SYNONYMS OF ENTITIES USING WEB SEARCH

(75) Inventors: Surajit Chaudhuri, Redmond, WA (US); Venkatesh Ganti, Redmond, WA (US); Dong Xin, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/465,832

(22) Filed: May 14, 2009

(51) Int. Cl. G06F 17/30

(52) U.S. Cl. 707/759; 704/9; 707/769; 707/736; 707/805

(57) ABSTRACT

Identifying synonyms of entities using web search results is disclosed herein. In some aspects, a candidate string of tokens of an entity name is selected as a search term. The search term is transmitted by a server to a search engine, which in turn, transmits search results back to the server after performing a search. The server analyzes the search results, generates a score based on the search results, and then determines a status (synonym or not a synonym) of the candidate string based on the score. In further aspects, additional candidate strings are designated as synonyms or not synonyms based on status of the searched candidate string by using relationships of a lattice formed from all possible candidate strings of the entity name.

### BACKGROUND

The Internet enables access to a vast archive of data that may be exploited to provide users with a great wealth of information. However, the enormous amount of information made available via the Internet may also be difficult navigate. For example, a search of the Internet using a term that is too generic may result in millions of results, many of which are unhelpful to a search recipient. Conversely, a search that is too specific or narrow may exclude many pertinent results that may be helpful to the search recipient.

When authors generate documents for publication, such as via the Internet, the authors are typically free to select descriptors (names, identifiers, etc.) for entities discussed in their documents. Often, authors shorten a long identifier of an entity (e.g., product, title, or other identifier) to create a shorter phrase to refer to the entity. These phrases can be an individual's preferred description of the entity. Thus, the descriptor is a short identifier of the entity's conventional name. Some entities include many descriptors which may make locating an entity during an Internet search more difficult than if the entity used a same identifier.

In an example, an author may refer to a product (entity) by only the model number (a possible descriptor) rather than a longer conventional name that may include the manufacturer, class, or other identifying features listed in a complete (formal) identifier of the product. Additionally, some authors may select different descriptors for identical entities such that an Internet search of only one descriptor may not retrieve all documents discussing the entity because some authors do not use the searched descriptor.

It is also important to process information quickly and efficiently when performing searches of large document sources, such as via an Internet search. It may be inefficient to search every possible descriptor of an entity when the entity's conventional name is relatively long. For example, an entity's conventional name may include more than five terms and thus over thirty possible descriptors, which in turn would lead to over thirty different document searches. Thus, it is important to minimize the number of searches by selecting only the most relevant descriptors.

### SUMMARY

Identifying synonyms of entities using web search results provided by a search engine is disclosed herein. In some aspects, a candidate string of tokens of an entity name is selected as a search term. The search term is transmitted by a server to a search engine, which, in turn, transmits search results back to the server. The server analyzes the search results, generates a score based on the search results, and then determines a status (synonym or not a synonym) of the candidate string based on the score.

In further aspects, additional candidate strings are designated as synonyms or not synonyms based on a status of the searched candidate string by using relationships of a lattice formed from all possible candidate strings of the entity name. Thus, the lattice may be exploited to determine the status of unsearched candidate strings.

In still further aspects, a similar and subsequent entity name may be analyzed to identify synonyms by using a cut of a similar entity name. The cut is a minimum number of candidate strings that need to be searched using the search engine to identify all of the synonyms of the entity name while exploiting the lattice relationships to determine the status of some unsearched candidate strings.

This summary is provided to introduce simplified concepts of identifying synonyms of entity names, which is further described below in the Detailed Description. This summary is not intended to identify essential features of the claimed subject matter, nor is it intended for use in determining the scope of the claimed subject matter.

### BRIEF DESCRIPTION OF THE DRAWINGS

The Detailed Description is described with reference to the accompanying figures. In the figures, the left-most digit(s) of a reference number identifies the figure in which the reference number first appears. The same reference number in different figures refers to similar or identical items.

FIG. 1 is a schematic of an illustrative environment to enable identifying synonyms of entities using a web search.

FIG. 2 is a block diagram of an illustrative computing environment to process an entity name via a computing device to generate a synonym list.

FIG. 3 is a block diagram of an illustrative data structure to enable using a web search result to generate a score for a search term of an entity name.

FIG. 4 is a flow diagram of an illustrative process of identifying synonyms of entities using a web search.

FIG. 5 shows an illustrative lattice having relationships of candidate strings generated for an entity name where lattice relationships may be exploited to identify synonyms of candidate strings without conducting additional web searches.

FIG. 6 shows the lattice of FIG. 5 where a portion of the candidate strings is identified as part of a cut that creates an optimized set of search terms for an entity name.

FIG. 7 is a flow diagram of an illustrative process of generating a synonym list using the lattice relationships of FIG. 5.

FIG. 8 is a flow diagram of an illustrative process of using the cut of the entity name shown in FIG. 6 for another entity name to select search terms.

FIG. 9 is a block diagram of an illustrative computing device that may be used to implement identification of synonyms of entities using web search data as shown in the environment of FIG. 1.

FIG. 10 is a block diagram of illustrative program modules shown in FIG. 9.

### DETAILED DESCRIPTION

### Overview

To enable more comprehensive document searches, it may be desirable to identify “synonyms,” of entity names by exploiting web search results obtained using selected token combinations (e.g., words forming a search term, etc.) of the entity name. The entity names are author-generated descriptors that are used to reference an entity. Synonyms with a strong correlation to the entity name may be identified by analyzing multiple uses of the synonym in various documents (e.g., accessible via a web search, etc.). Synonyms may be helpful to enable searching documents sources, such as the Internet, to locate relevant information for an entity.

Synonyms may be determined after testing candidate strings that are selected from tokens of an entity name. A web search may be performed using some of the candidate strings as search terms. The web search results may be analyzed to determine whether the searched candidate string is a synonym of the entity name. A list of synonyms may be generated for an entity name. These techniques, and others, are discussed in more detail below.

### Illustrative Environment

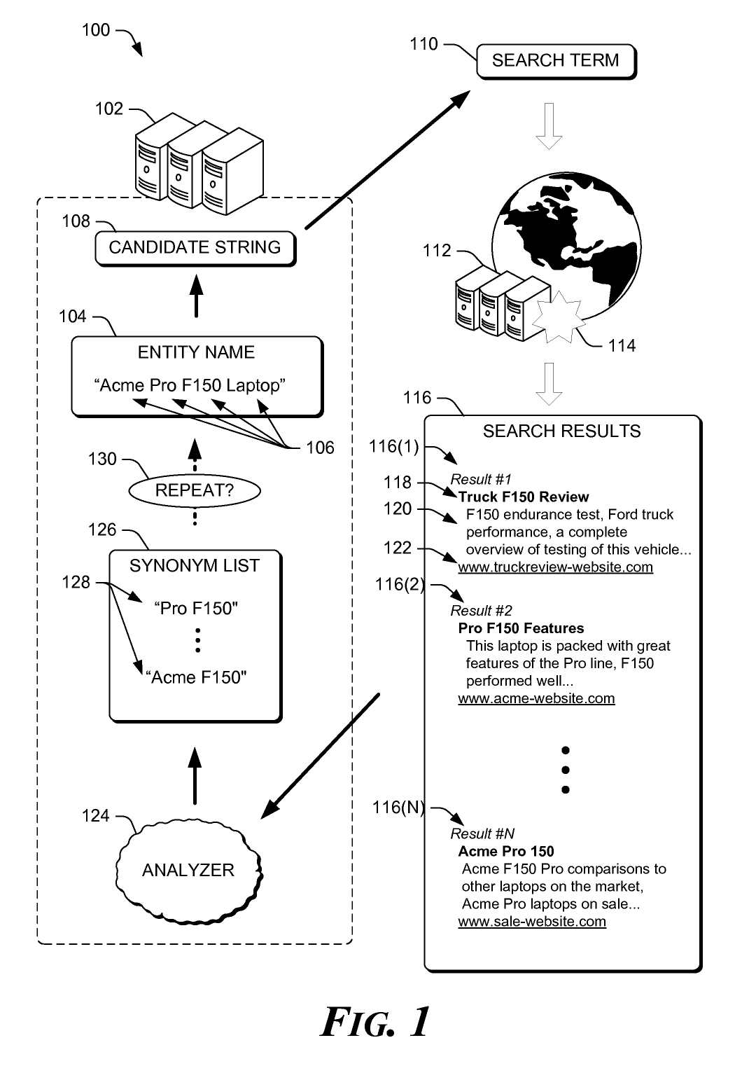

FIG. 1 is a schematic of an illustrative environment 100 to enable identifying synonyms of entities using a web search. The environment 100 may include one or more servers 102 that are used to process data, communicate with other computing devices via a network, and output data for storage and/or display to a user.

The servers 102 may store an entity name 104. The entity name is a conventional name of a known entity. Entities may be products, titles, subjects, or anything else an author may use to describe something of interest. For example, the entity name 104 of a particular computer may be “Acme Pro F150 Laptop.”

The entity name 104 is used to generate a candidate string 108. The candidate string is a subset of the tokens 106 from the entity name 104. For example, the entity name 104 of “Acme Pro F150 Laptop” includes four tokens. Using unique combinations of these tokens, fifteen (2⁴−1=15) unique instances of the candidate string 108 may be created by the servers 102.

The servers 102 may transmit the candidate string 108 as a search term 110 to web servers 112. The web servers 112 may receive the search term 110, process the search term using a search engine 114, and return search results 116 based on the search term 110. The search results 116 may include many individual search results 116(1), 116(2), . . . , 116(N), each having various pieces of information such as a title 118, a snippet 120 (text from a document), a uniform resource locator (URL) 122, and so forth.

The servers 102 may receive the returned search results 116 via an analyzer 124. The analyzer 124 may analyze the search results 116 using the candidate string 108, the tokens 106 of the entity name 104, or other relevant data to determine whether the candidate string 108 (used as the search term 110) is a synonym of the entity name 104. When the analyzer 124 determines that the candidate string is a synonym of the entity name, then the candidate string 108 may be stored in a synonym list 126 and designated as a synonym 128. Otherwise, the candidate string 108 may be designated as not a synonym. When additional candidate strings need to be tested to determine whether they are synonyms of the entity name 104, then the servers 102 may repeat the process via a recursive operation 130 to test any remaining candidate strings.

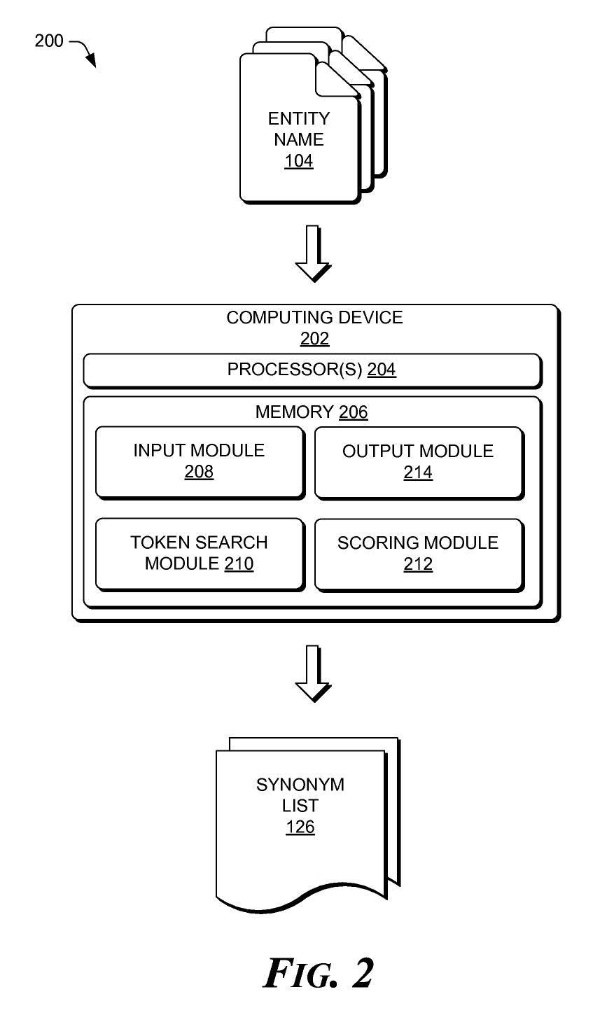

FIG. 2 is a block diagram of an illustrative computing environment 200 that may be used to process the entity name 104 via a computing device 202 to generate a synonym list. The environment 200 includes the computing device 202 that may be configured to accept the entity name 104 that may be tested and/or analyzed to ultimately generate the synonym list 126. The entity name 104 may be determined by a producer of the entity, an authority such as a dictionary, or from other sources. The synonym list 126 may be stored for future use such as on a tangible storage medium (via local or remote storage). In an example, the synonym list 126 may be used to locate a comprehensive list of documents (e.g., via an Internet search, database search, etc.) that discuss the entity. The documents may be used for various purposes, such as for analyzing offers for sale of the entity, determining a sentiment of the documents for the entity, or for other research, analysis, or exploitation.

The computing device 202 may include one or more processors 204 and a memory 206. The memory 206 may include volatile and/or nonvolatile memory, removable and non-removable media implemented in any method or technology for storage of information, such as computer-readable instructions, data structures, program modules or other data. The memory 206 of the computing device 202 may store a number of components such as an input module 208, a token search module 210, a scoring module 212, and an output module 214, among other possible components.

The input module 208 may be configured to receive the entity name(s) 104 for processing by the computing device 202. For example, and without limitation, the input module 208 may include a user interface that enables a user to selectively provide one or more of the entity names 104, which may be received by the input module 208 and stored by the computing device 202 for further processing.

In some embodiments, the token search module 210 may perform a variety of operations that may begin with determining the candidate string 108 from the entity name 104. The token search module 210 may use the candidate string 108 to perform a search (using the search term 110), which ultimately may enable receipt of the search results 116 by the computing device 202.

In accordance with various embodiments, the scoring module 212 may analyze the search results 116, in combination with other available data such as the entity name 104, the tokens 106, the candidate string 108, and so forth to generate a score for the candidate string 108 used as the search term 110. The score may correlate to a likelihood of the candidate string 108 being a synonym 128 of the entity name 104. For example, the score may be compared to a threshold value, which, when reached and/or surpassed by the score, indicates that the candidate string is a synonym of the entity name 104.

Finally, the output module 214 may output synonyms 128 for inclusion in the synonym list 126. For example, the output module 214 may store the candidate string 108 as the synonym 128 in the synonym list 126 when the score indicates that the candidate string is a synonym. The synonyms may be stored in the synonym list 126 upon designation as a synonym or the synonyms may be stored in the synonym list 126 via a batch process.

### Illustrative Operation

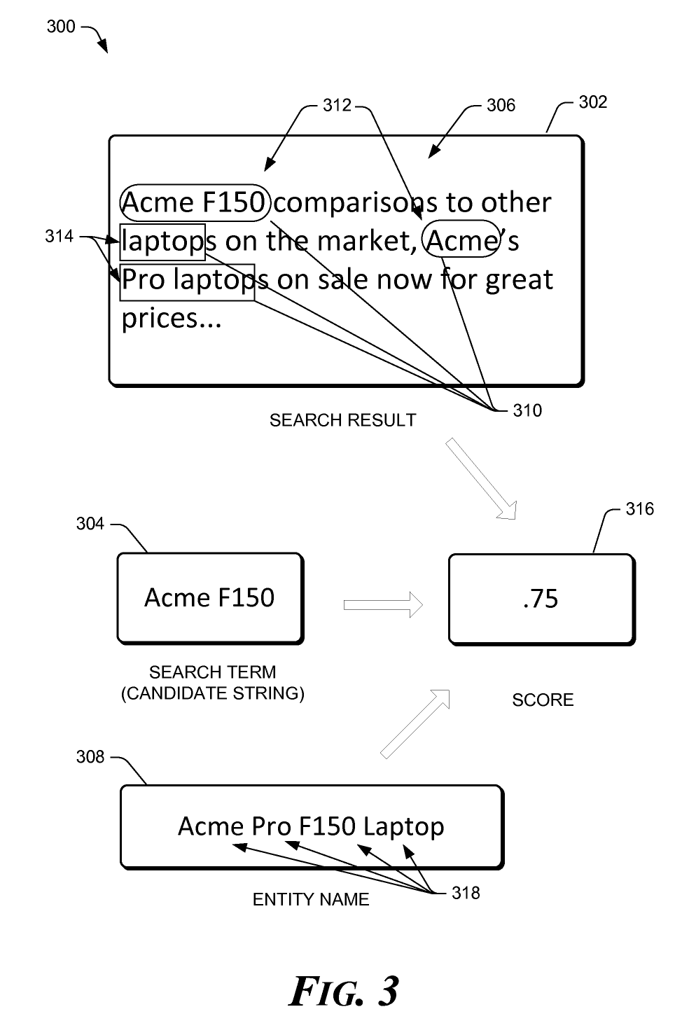

FIG. 3 is a block diagram of an illustrative data structure 300 to enable using a web search result to generate a score for a search term of an entity name. The process 300 may use a search result 302 that includes one or more tokens (terms) included in the search term 304 (e.g., “Acme” and/or “F150”). For example, the search result may be generated by passing the search term 304 to the search engine 114, which retrieves search results that include text 306, such as the title 118, the snippet 120, the URL 122, and so forth. In addition or as an alternative, the search result may be a summary, abstract, or other portion of a document that is located via a search. The search engine 114 may retrieve the search result 302 based on various factors, such as the occurrence of the terms of the search term 304 in a document available to the search engine.

In some embodiments, the size (or gap) of the search result may be predetermined or set to a maximum size. In this way, unusual sections of the text 306 may be reduced in size to create a more consistent comparison between the search results. Typically, the snippet 120 that is produced by a search engine 114 is of a predetermined number of words, characters, or the like, and thus the gap is fairly consistent for the snippets 120 returned by the search engine.

The text 306 of the search result 302 may include some instances of tokens 310 that are included in the entity name 308 in addition to the tokens of the search term 304. For example, some of the tokens 310 may be search tokens 312 of the search term 304 while other instances of entity tokens 314 may not be included in the search terms. Some of the tokens may be contiguous while other tokens may be separated by various amounts of the text 306.

In accordance with some embodiments, a score 316 may be generated for the search result 302 based on the tokens 310 located in the search result. For example, the score 316 may be based on the number or percent of the tokens 310 (e.g., absolute, unique occurrence, etc.) in the search result as compared to the tokens 318 of the entity name. Additional scoring techniques are discussed below. The score 316 may then be used to determine whether the search term 304, which is derived from the candidate string 108, is a synonym of the entity name 308.

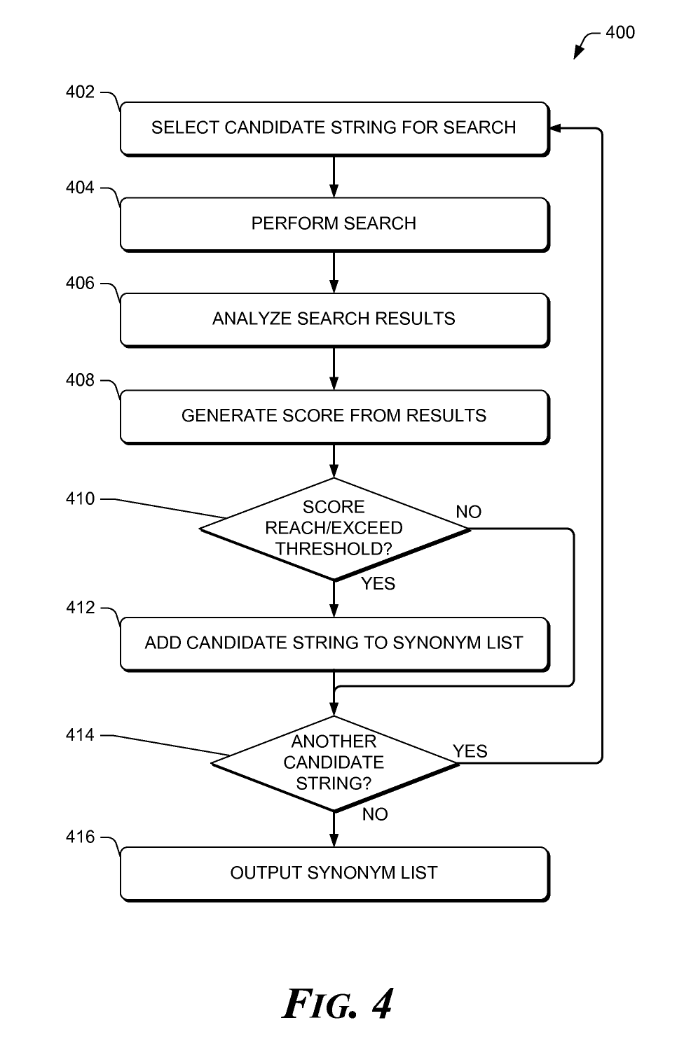

FIG. 4 is a flow diagram of an illustrative process 400 of identifying synonyms of entities using a web search. The process 400 is illustrated as a collection of blocks in a logical flow graph, which represent a sequence of operations that can be implemented in hardware, software, or a combination thereof. The collection of blocks is organized under respective entities that may perform the various operations described in the blocks. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure, in addition to the process 400, shall be interpreted accordingly.

At 402, the server 102 may select the candidate string 108 from tokens 106 in the entity name 104. The candidate string 108 may be selected randomly or via a selection algorithm that methodically selects the candidate strings in a predetermined order.

At 404, the candidate string 108 may be transmitted to a search engine (e.g., the search engine 114) as the search term 110 to perform a web search of documents that include the candidate string (i.e., the search term). The token search module 210 may facilitate transmission of the search term and receipt of the search result 116. The search may retrieve a portion of relevant documents as the search result 116. For example, the search result 116 may return a number of relevant documents, each including the title, 118, the snippet 120, the URL 122, and so forth of search results generated by the search engine 114. In some embodiments, only a predetermined number of the search results 116 may have information transmitted back to the server 102. For example, the server 102 may only store the information from the first 10, 20, etc. search results.

In accordance with embodiments, the search results 116 may be analyzed at 406. For example, the tokens 106 of the entity name 104 may be located in the search results.

At 408, the scoring module 212 may use the located tokens from the analysis at the operation 406 to compute a score for each search result. In some embodiments, a single score may be computed that is representative of the score for each search result for the candidate string (e.g., average, median, etc.) to create a representative search result score.

In some embodiments, the score may be assigned to each search result based on whether all (or a predetermine number) of the tokens 106 of the entity name 104 are included in the search result, thus the score may be {0,1}. For example, a value of “1” may be given to a search result with at least one occurrence of each token in the search result. Averaging all the scores of all of the search results may generate a representative score for the searched candidate string. In some embodiments, other techniques and/or calculations may be used to generate a score for each search result. For example, a score may be generated that weighs the quantity of the tokens in the search result as compared to the total number of tokens in the entity name. This score may result in a fractional score (e.g., 0.33 for one third of the tokens in the search result). Other scoring algorithms are contemplated that provide different weights (absolute, linear, exponential, etc.) to tokens in the search result.

At 410, the scoring module 212 may determine whether the score generated at 408 at least reaches a threshold. When the score at least reaches the threshold, the candidate string may be designated as a synonym and added to the synonym list 126 at 412.

At 414, the server 102 may determine whether another candidate string needs to be searched and scored to determine whether it is a synonym. If the score does not at least reach the threshold at 410, then the process 400 may move directly to the operation 414.

Finally, when no candidate strings need to be searched and scored, the synonym list may be outputted at 416. For example, the synonym list 126 may be stored in a tangible storage medium for later use, outputted to a user for further processing (display, etc.), or transmitted to another processes for further data processing (e.g., web crawling, product search, sentiment classification, etc.).

### Additional Embodiments

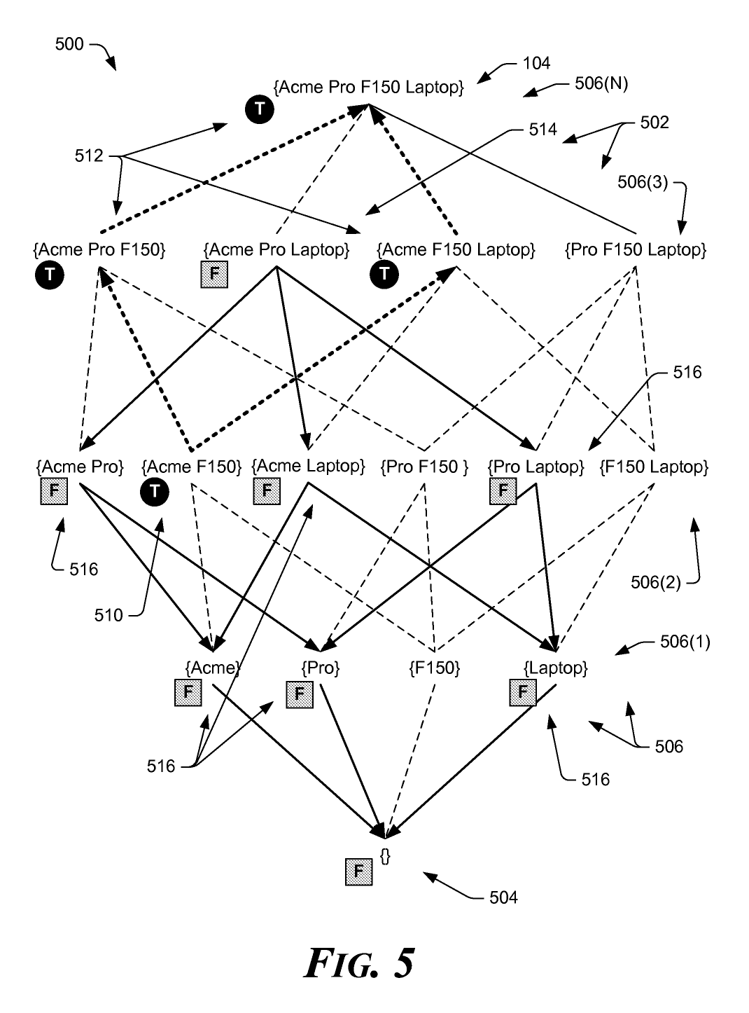

FIG. 5 shows an illustrative lattice 500 having relationships of candidate strings 502 generated for an entity name in which lattice relationships may be exploited to identify synonyms of searched terms without conducting additional web searches. The lattice 500 may be formed by identifying each possible candidate string for the entity name 104. The entity name 104 may be placed at one end of the lattice 500 opposite an empty subset 504 (used as a reference point). Layers 506(1), . . . , 506(N) of candidate strings may be included, whereby each of the layers 506 includes an incrementally increasing number of tokens (previous layer number of tokens plus one additional token). For example, a first layer 506(1) may include the individual tokens as the candidate strings while the last layer 506(N) may include all of the tokens (and thus the entity name 104).

In accordance with some embodiments, each of the candidate strings 502 of the lattice 500 may be connected to related candidates strings that share the same tokens in an adjacent level. For example, a candidate string of “Pro F150” may be related to a subset of an adjacent layer (e.g., the layer 506(1)) of the candidate strings “Pro” and “F150.” Similarly, the candidate string of “Pro F150” may be related to a superset of an adjacent later (e.g., the layer 506(3)) of the candidate strings “Acme Pro F150” and “Pro F150 Laptop.” Although the lattice 500 shows relationships using dashed lines, the relationships may be stored using tags or other designations.

In accordance with various embodiments, the lattice 500 may be used to select some candidate strings as search terms for a search (e.g., the operation 404 of the process 400) while other candidate strings may be pruned (designated as synonyms or not synonyms) based on the searched candidate string's status (i.e., synonym or not a synonym). Thus, the lattice 500 may enable a more efficient processing and population of the synonym list 126 by only searching a portion of the candidate strings 502 and pruning the remaining candidate strings.

A first assumption of the lattice 500 provides that when a candidate string is determined to be a synonym, then all related supersets of candidate strings are also assumed to be synonyms. For example, a tested candidate string 510 of “Acme F150” may be determined to be a synonym (“T”=true) of the entity name “Acme Pro F150 Laptop.” Using the first assumption, the superset candidate strings 512 of “Acme Pro F150,” “Acme F150 Laptop,” and “Acme Pro F150 Laptop” are all designated as synonyms, which may be included in the synonym list 126. As shown in FIG. 5, the bold dashed line shows the relationship connection between the tested candidate string 510 of “Acme F150” and the superset candidate strings 512. Thus, by performing a search using the candidate set “Acme F150,” three additional candidate strings may be pruned when the searched candidate set is determined to be a synonym of the entity name 104, where the pruned candidate strings are designed as synonyms of the entity name.

A second assumption of the lattice 500 provides that when a candidate string is determined not to be a synonym (“F”=false), then all related subsets of candidate strings are also assumed not to be synonyms. The second assumption is a corollary of the first assumption. For example, another tested candidate string 514 of “Acme Pro Laptop” may be determined not to be a synonym of the entity name “Acme Pro F150 Laptop.” Using the second assumption, the subset candidate strings 516 of “Acme Pro,” “Acme Laptop,” “Pro Laptop,” “Acme,” “Pro,” and “Laptop” are all designated as not synonyms, which may be excluded from the synonym list 126 and designated as not a synonym. As shown in FIG. 5, the solid line shows the relationship connection between the other tested candidate string 514 of “Acme F150 Laptop” and the subset candidate strings 516. Thus, by performing a search using the candidate set “Acme Pro Laptop,” five additional candidate strings may be pruned when the searched candidate set is determined not to be a synonym of the entity name 104, by which the pruned candidate strings are designed as not synonyms of the entity name.

Accordingly, by pruning the candidate strings 502 of the lattice 500 using the first and second assumptions, the total number of candidate strings that need to be searched via a search engine may be significantly reduced. This may ultimately result in a less resource intensive way to populate the synonym list 126 and may also reduce a demand (number of searches to perform) on one or more search engines.

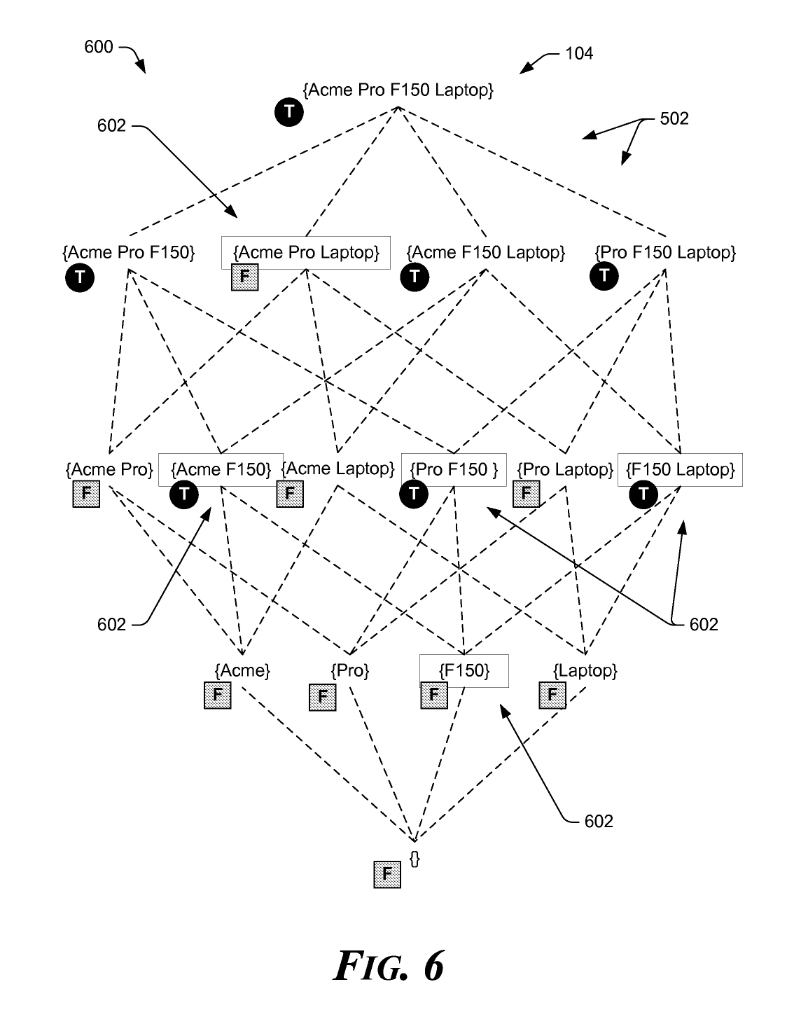

FIG. 6 shows the lattice of FIG. 5 in which a portion of the candidate strings 502 are identified as part of a cut 602 that creates an optimized set of search terms for an entity name. The cut 602 is defined by a set of all minimal positive and maximal negative subsets plus any other candidate strings that have an unknown status as a synonym or not a synonym. In other words, the cut 602 identifies the minimum number of candidate strings 502 necessary to search via the search engine 114 as search terms 110 in order to identify all synonyms 128 of the entity name 104.

The cut 602, once identified by searching various candidate strings of the entity name 104, may be helpful when performing synonym identification on subsequent entity names that are similar to the entity name 104 used to create the cut. For example, if another entity name of “Acme Expert F150 Laptop” is to be searched, the cut 602 may be used to select candidate strings for searching as search terms. If the selected candidate strings are identified as synonyms (“T”) or non synonyms (“F”) in the same fashion as the candidate strings of the entity name 104 used to create the cut, then no further searching is necessary because all synonyms will be located using the cut 602. However, if some of the candidate strings in the cut 602 product results (“T” or “F”) that are inconsistent with the results from the entity name 104 used to create the cut 602, then further candidate string processing may be necessary because the first and second assumptions may not prune the remaining candidate strings.

In some instances, the cut 602 may include one outlier candidate string 604 (e.g., “F150”), which could not be removed via pruning. In this example, the outlier candidate string 604 happens to identify another popular product of a Ford® pickup truck, which may be apparent in many search results using this term. Thus, this single token search term may not be a synonym only because the term was made popular by another entity name. Although the outlier candidate string 604 presents a special scenario, similar situations are contemplated which require expanding the cut across additional candidate strings in the lattice 500.

The cut may be implemented using one or more techniques. In some embodiments, a depth-first schedule may be used that starts with the maximal (or minimal) subset, and schedules subsets for validation by following the edges of the structure of the lattice 500. The depth-first schedule may start with a top root node (or alternatively, a bottom node) and recursively traverse the lattice structure. When an algorithm reaches a node corresponding to a subset at some stage, the next subset to validate may be determined by looking for children, then siblings, and then retracing to the parent and continues to the next subset, among other possible algorithms that may traverse the lattice 500.

In various embodiments, a maximum-benefit schedule may used that considers all subsets simultaneously (or substantially simultaneously). The maximum-benefit schedule may not be confined to the lattice structure. Instead, at any stage, all subsets may be considered and the one with the maximum estimated benefit may be selected. The benefit may be computed by the number of subsets that are expected to be pruned.

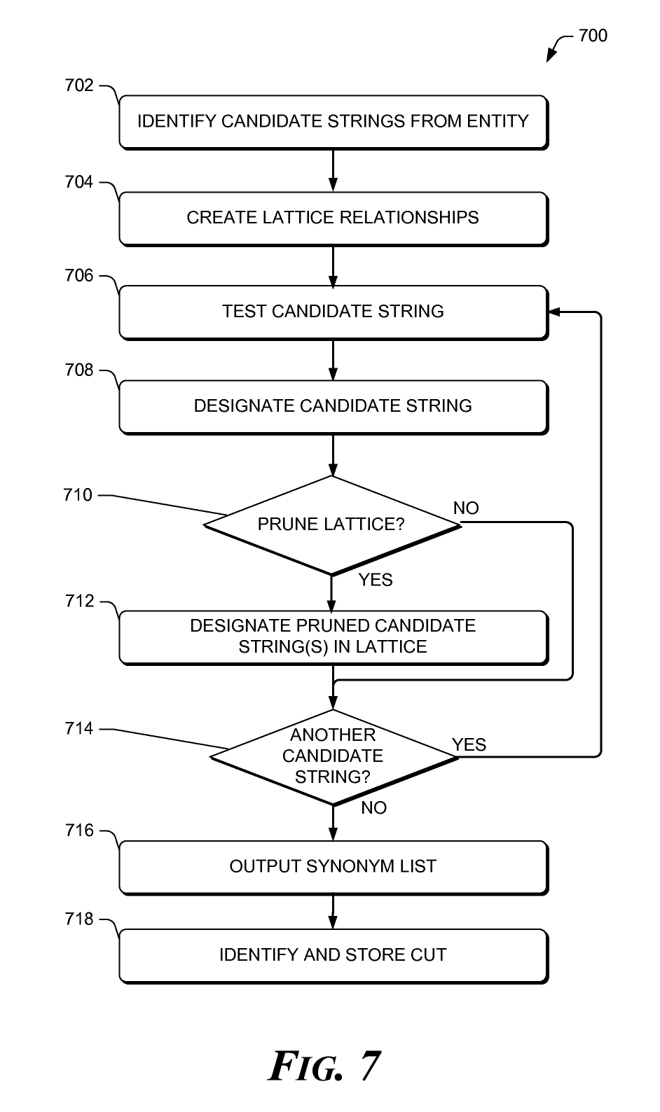

FIG. 7 is a flow diagram of an illustrative process 700 of generating a synonym list using the lattice relationships of FIG. 5. The order in which operations are described is not intended to be construed as a limitation, and any number of the described blocks can be combined in any order and/or in parallel to implement the process 700.

At 702, the candidate strings 502 of the entity name 104 are identified by the token search module 210. For example, when the entity name 104 includes four tokens, then fifteen candidate strings are present (2⁴−1=15).

At 704, the token search module 210 may create the lattice relationships to form the lattice 500. As discussed in reference to FIG. 5, the lattice 500 may be created by identifying candidate strings that are subsets and/or supersets of other candidate strings and then linking those candidate strings accordingly.

At 706, a candidate string may be selected as a search term 110 and used to perform a search using the search engine 114. For example, testing the candidate string 706 may determine the status of the candidate string (synonym or not a synonym) according to the process 400.

At 708, the candidate string may be designated as a synonym or not a synonym, such as by the scoring module 212. For example, a score may be calculated for the candidate string and compared to a threshold value (the operations 408, 410 of the process 400) to determine the status of the candidate string.

At 710, the token search module 210 may prune candidate strings from being selected as search terms, and may designate these candidate strings as synonyms or not synonyms based on the first and second assumptions described above with reference to the lattice 500 of FIG. 5. When the lattice 500 can be pruned at 710, the pruned candidate string(s) are designated as synonyms or not synonyms by the server 102.

At 714, the token search module 210 may determine whether another candidate string needs to be searched and scored to determine whether it is a synonym. If the lattice is not pruned at 710, then the process 700 may move directly to the operation 714.

In some embodiments, when no additional candidate strings are to be searched and scored, the synonym list may be outputted at 716. For example, the synonym list 126 may be stored in a tangible storage medium for later use, outputted to a user for further processing (display, etc.) or transmitted to another processes for further data processing (e.g., web crawling, product search, sentiment classification, etc.).

In accordance with various embodiments, at 718, the server 102 may identify and store the cut 602, as determined during the pruning operations of 710, 712. The cut 602 may be the optimized set of search terms (candidate strings) for the entity name used for the process 700. The cut 602 identifies the minimum number of candidate strings 502 necessary to search via the search engine 114 as search terms 110 in order to identify all synonyms 128 of the entity name 104, by employing the first and second assumptions discussed above with reference to FIG. 5.

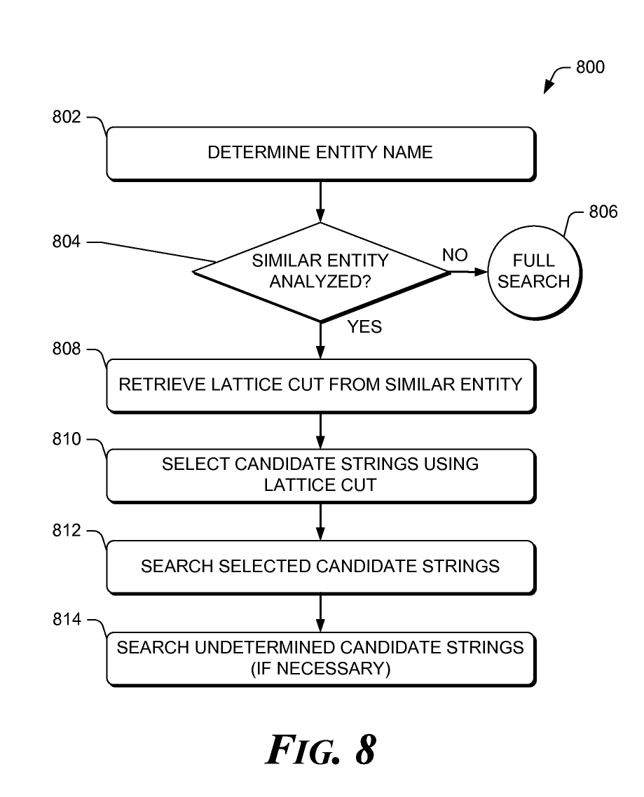

FIG. 8 is a flow diagram of an illustrative process 800 of using the cut 602 of the entity name shown in FIG. 6 for another entity name to select search terms. The order in which operations are described is not intended to be construed as a limitation, and any number of the described blocks can be combined in any order and/or in parallel to implement the process 800.

At 802, an entity name of an additional entity may be determined by the server 102. For example, the server 102 may process many entity names to determine synonyms for each entity name. The process 800 may be performed each time a new entity name is selected for analysis and identification of synonyms.

At 804, the server 102 may determine whether a similar entity name has been analyzed, such as via the process 700. A similar entity name may be an entity name that shares the same (or substantially the same) number of tokens, of which at least a portion of the tokens are similar or identical to those of the additional entity name selected at the operation 802. When a similar entity name is not located at the operation 804, then a full analysis of the additional entity name may be performed at 806, such as via the process 400 and/or the process 700.

In accordance with some embodiments, when a similar entity is located at the operation 804, the server 102 may retrieve the cut 602 from the similar entity having the similar entity name at 808. For example, the cut 602 is described with reference to FIG. 6 and may be stored at the operation 718 of the process 700.

At 810, the token search module 210 may select candidate strings of the additional entity name using the cut 602. For example, using the cut 602 described with reference to FIG. 6, the five candidate strings may be identified from the additional entity name and searched via a search engine to determine whether the candidate strings are synonyms. Pruning may then be conducted on the lattice 500 by employing the first and second assumptions. In some instances, some candidate strings may remain undetermined by the pruning process, such as when the results of processing the cut for the similar entity name are different that the results of processing the cut for the additional entity name. In such instances, any remaining undetermined candidate strings may be determined at 814.

The processes 700 and 800 may be applied to individual processing of entities, and additionally (possibly with some variations) to process multiple entities substantially simultaneously. Multiple entity scheduling may be performed by leveraging an implicit structure of names of entities. This may result in an efficient processing of the entity names when the implicit structure is exploited. A structure may be obvious from the following example of two products by a same producer: “Acme Pro F150 Laptop” and “Acme Pro F160 Laptop,” which may belong to the same laptop series from “Acme.” After processing “Acme Pro F150 Laptop,” a determination may be made that F160 belongs to the cut as described in the process 800. Identification of structural similarity across entities may validate F160 in the lattice structure. Depending on the outcome of validation, the scheduling algorithm may terminate early or proceed further as described in the process 800 at the operation 814.

In accordance with some embodiments, entities that are structurally similar may be grouped together to build a connection across multiple entities. A group profile may be created that aggregates statistics from entities in the group that have been processed using the process 700.

In order to share statistics for improved scheduling across entities, the statistics may have to be on the same subset lattice structure. Otherwise, it may be much harder to exploit them. Therefore, a constraint on grouping multiple entities together for statistics collection may be an ability to easily aggregate statistics across entity lattices. In some embodiments, normalization rules may take as an input a single token and map it to a more general class, all of which are accepted by a regular expression. An outcome may be entities that share a same normal form (characterized by a sequence of token level regular expressions) may all may be grouped together. More importantly, they may share the same subset lattice structure.

Finally, after grouping entities into multiple partitions, the entities may be processed one group at a time. When processing begins, there may be no statistics on the group, but data may be obtained after each entity name is processed. Next, a cut with a maximum benefit may be selected from the group, similar to the maximum benefit schedule. The selected cut may be used for processing a subsequent entity and may have a higher probability of advancing an entity via the cut (the process 800) without additional processing of the operation 814.

### Illustrative Computing System

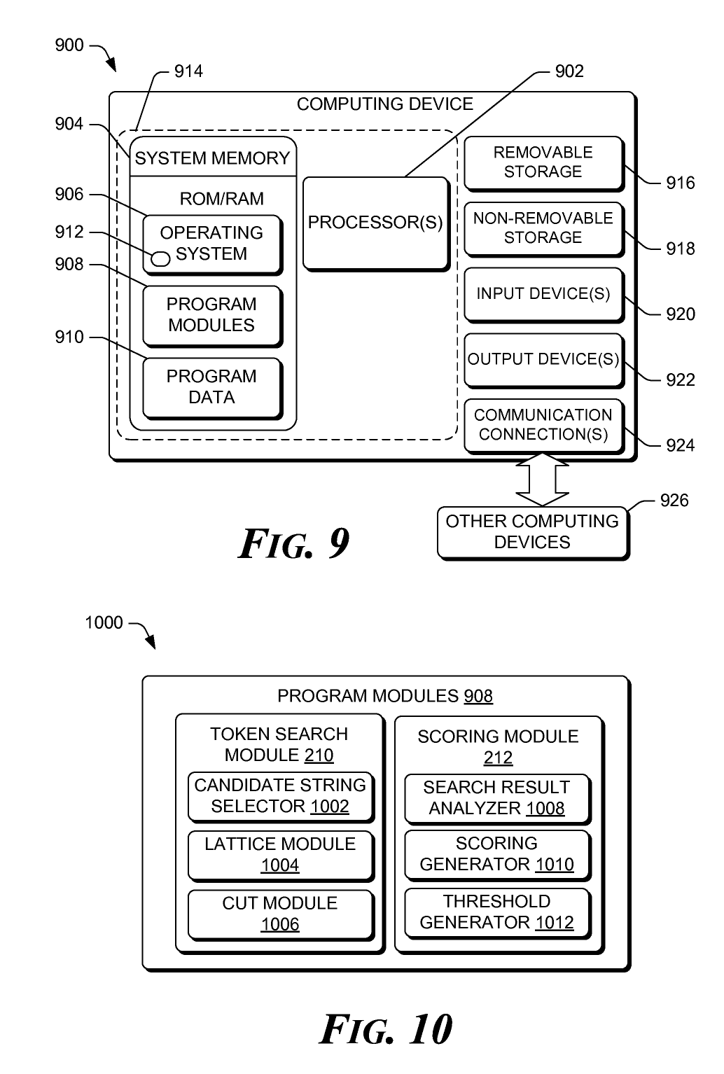

FIG. 9 is a block diagram of an illustrative computing device 900 that may be used to implement identification of synonyms of entities using web search data as shown in the environment of FIG. 1. It will readily be appreciated that the various embodiments of synonym identification techniques and mechanisms may be implemented in other computing devices, systems, and environments. The computing device 900 shown in FIG. 9 is only one example of a computing device and is not intended to suggest any limitation as to the scope of use or functionality of the computer and network architectures. The computing device 900 is not intended to be interpreted as having any dependency or requirement relating to any one or combination of components illustrated in the example computing device.

In a very basic configuration, the computing device 900 typically includes at least one processing unit 902 and system memory 904. Depending on the exact configuration and type of computing device, the system memory 904 may be volatile (such as RAM), non-volatile (such as ROM, flash memory, etc.) or some combination of the two. The system memory 904 typically includes an operating system 906, one or more program modules 908, and may include program data 910. The operating system 906 includes a component-based framework 912 that supports components (including properties and events), objects, inheritance, polymorphism, reflection, and provides an object-oriented component-based application programming interface (API). The computing device 900 is of a very basic configuration demarcated by a dashed line 914. Again, a terminal may have fewer components but will interact with a computing device that may have such a basic configuration.

The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by removable storage 916 and non-removable storage 918. Computer storage media may include volatile and nonvolatile, removable and non-removable media implemented in any method or technology for storage of information, such as computer readable instructions, data structures, program modules, or other data. The system memory 904, the removable storage 916, and the non-removable storage 918 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 900. Any such computer storage media may be part of the computing device 900. The computing device 900 may also have input device(s) 920 such as keyboard, mouse, pen, voice input device, touch input device, etc. Output device(s) 922 such as a display, speakers, printer, etc. may also be included. These devices are well known in the art and are not discussed at length here.

The computing device 900 may also contain communication connections 924 that allow the device to communicate with other computing devices 926, such as over a network. These networks may include wired networks as well as wireless networks. The communication connections 924 are one example of communication media. The communication media may typically be embodied by computer readable instructions, data structures, program modules, etc.

It is appreciated that the illustrated computing device 900 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like. For example, some or all of the components of the computing device 900 may be implemented in a cloud computing environment, such that resources and/or services are made available via a computer network for selective use by client devices.

FIG. 10 is a block diagram of illustrative program modules 1000 shown in FIG. 9. The illustrative modules may be integrated with the program modules 908 as described above with the computing device 900.

In accordance with various embodiments, the token search module 210 may include a candidate string selector 1002, a lattice module 1004, and a cut module 1006. The candidate string selector 1002 may be used to select unique combinations of the tokens 106 to create the candidate strings 108 from the entity name 104. In addition, the candidate string selector may determine candidate strings that are to be searched by the search engine 114 to determine a status of the candidate strings (i.e., synonym or not synonym).

The lattice module 1004 may generate the lattice 500 and respective relationships between the candidate strings 502 in the levels 506 of the lattice. For example the lattice module 1004 may generate the lattice 500 shown in FIG. 5, which includes indicated relationships between at least a portion of the candidate strings 502 of the entity name 104. In addition, the lattice module 1004 may be used to prune candidate strings by implementing the first and second assumptions to reduce the number of candidate strings that are searched via the search engine 114.

The cut module 1006 may be used to create the cut 602 as shown in FIG. 6. For example, the cut module 1006 may determine the optimal candidate strings that need to be analyzed for a particular entity name after the synonyms for the entity name have been identified. The cut module 1006 may then store the cut 602 for use with a similar entity via the process 800. The cut module 1006 may also select a cut when a similar entity is analyzed via the process 800 to efficiently identify synonyms of the similar entity without analyzing candidate strings that are not in the cut 602, unless the statuses of the candidate strings remain unknown after analyzing the cut.

In accordance with some embodiments, the scoring module 212 may include a search result analyzer 1008, a score generator 1010, and a threshold generator 1012. The search result analyzer 1008 may analyze the search results 116 received from the search engine 114. For example, the search result analyzer 1008 may identify the tokens 106 included in the entity name 104 in the search results 116.

The score generator 1010 may generate a score for each of the search results 116 or a cumulative score for all of the search results. In the former case, the score generator 1010 may generate a representative score for the searched candidate string (e.g., an average, a median, etc.). The score generator 1010 may then compare the candidate string score to a threshold value to determine whether the candidate string is a synonym 128 or not a synonym of the entity name 104.

The threshold generator 1012 may be used to generate (or designate) the threshold value, which is used in comparison the score as discussed immediately above. In some embodiments, the threshold generator 1012 may be static (e.g., obtained from a user input, etc.) or dynamic (e.g., intermittently calculated). Thus, the threshold generator 1012 may generate a dynamic threshold value based on a machine learning model to adjust the threshold value based on one or more pieces of information, such as synonym confirmation and designation information among other possible pieces of information.

### CONCLUSION

The above-described techniques may be used to identify synonyms of entities using web search data. Although the techniques have been described in language specific to structural features and/or methodological acts, it is to be understood that the appended claims are not necessarily limited to the specific features or acts described. Rather, the specific features and acts are disclosed as exemplary forms of implementing such techniques.

What is claimed is:

1. A method of identifying synonyms of an entity name, the method comprising:
transmitting a search term to a web server, the search term being a candidate string selected from tokens of the entity name
receiving a plurality of search results from the web server, the search results including at least one of a title, a uniform resource locator (URL), and a snippet of content of a web page;
identifying tokens of the entity name that are included in the plurality of search results;
generating a score for the plurality of search results based on the identified tokens;
comparing the generated score to a threshold value used to indicate whether the candidate string is a synonym of the entity name; and
storing the candidate string as a synonym when the generated score at least reaches the threshold value.

2. The method as recited in claim 1, further comprising using the synonyms in the synonym list to retrieve documents associated with the entity name.

3. The method as recited in claim 1, wherein the generating the score includes counting unique instances of the identified tokens from the search results and assigning a numerical value to the search result based on the count of the unique instances of the identified tokens.

4. The method as recited in claim 1, further comprising generating a lattice for the candidate strings of the entity name, wherein the lattice relates incremental subsets and supersets of each candidate string a related candidate string.

5. The method as recited in claim 4, further comprising:
designating an additional candidate string that is a superset of the candidate string as a synonym of the entity name when the candidate string is a synonym; and
designating an additional candidate string that is a subset of the candidate string as not a synonym of the entity name when the candidate string is not a synonym.

6. The method as recited in claim 5, further comprising:
determining a cut of the lattice by identifying a minimum number of specific candidate strings that can be searched to determine all of the synonyms of the entity name using at least one of a depth-first schedule or a maximum-benefit schedule; and
selecting candidate strings of a subsequent entity name from a profile grouping of similarly structured entity names to efficiently determine the cut.

7. One or more computer-readable media storing computer-executable instructions that, when executed on one or more processors, causes the one or more processors to perform acts comprising:
receiving search results for a candidate string from a search engine, the candidate string selected from a unique combination of tokens of an entity name;
generating a score for the candidate string based on instances of tokens present in the search results to determine a status of the candidate string of the entity name, the status being at least one of a synonym or not a synonym; and
storing the candidate string as a synonym when the score at least reaches a threshold value.

8. The one or more computer-readable media as recited in claim 7, wherein the acts further comprise pruning at least one candidate string of the entity name after the status of the searched candidate string is determined, wherein the pruning determines the status of the at least one candidate string by exploiting a lattice of the candidate strings of the entity name by:
designating the at least one candidate string that is a superset of the candidate string as a synonym of the entity name when the candidate string is a synonym; and
designating the at least one candidate string that is a subset of the candidate string as not a synonym of the entity name when the candidate string is not a synonym.

9. The one or more computer-readable media as recited in claim 8, wherein the lattice includes layers of candidate strings that are linked to at least one of a subset or a superset of candidate strings in the layers.

10. The one or more computer-readable media as recited in claim 8, wherein the acts further comprise determining a cut of the lattice by identifying a minimum number of specific candidate strings that need to be scored and pruned to determine all the synonyms of the entity name using at least one of a depth-first schedule or a maximum-benefit schedule.

11. The one or more computer-readable media as recited in claim 10, wherein the acts further comprise:
analyzing a subsequent entity name to determine synonyms of the subsequent entity name; and
selecting subsequent candidate strings of the subsequent entity name to search via a search engine based on the cut.

12. The one or more computer-readable media as recited in claim 7, wherein the acts further comprise selecting another candidate string for determination of the status until all candidate strings of the entity name have been identified as a synonym or not a synonym.

13. The one or more computer-readable media as recited in claim 7, wherein the acts further comprise outputting a synonym list that includes all of the synonyms of the entity name.

14. A method, comprising:
creating a lattice of candidate strings selected from tokens of an entity name to establish a hierarchical relationship between the candidate strings;
sending a first candidate string of the lattice to a web search engine to perform a web search, the web search to return web search results;
generating a score based on instances of the tokens of the entity name included in the web search results;
designating the first candidate string as a either a synonym of the entity name when the score at least reaches a threshold value or as not a synonym; and
updating the lattice with the status of the first candidate string.

15. The method as recited in claim 14, further comprising designating a second candidate string in the lattice as either a synonym or not a synonym based on the relationship of the second candidate string to the first candidate string.

16. The method as recited in claim 15, wherein the second candidate string is designated as a synonym when the second candidate string is a superset of the first candidate string and the first candidate string is a synonym of the entity name.

17. The method as recited in claim 16, wherein the second candidate string is designated as not a synonym when the second candidate string is a subset of the first candidate string and the first candidate string is not determined to be a synonym of the entity name.

18. The method as recited in claim 17, further comprising identifying a cut of the lattice using at least one of a depth-first schedule or a maximum-benefit schedule, the cut defined by a minimum number of specific candidate strings to be used as search terms in a search via a search engine to determine all of the synonyms of the entity name, the cut being usable by a similar entity name to expedite synonym identification of the similar entity name.

19. The method as recited in claim 14, wherein generating the score is based on the quantity of unique tokens in the entity name, and wherein the web search results includes a snippet of text from a document, the snippet including at least one token from the first candidate string.

20. The method as recited in claim 14, further comprising:
populating a synonym list with the designated first candidate string as the synonym, and
storing the synonym list.
